(19) United States
(12) Patent Application Publication
(10) Pub. No.: US 2010/0070370 A1
(43) Pub. Date: Mar. 18, 2010

(54) System and Method of Providing Peer-to-Peer Message-Based Advertising

(76) Inventor: JOSEPH WALTMAN, Newport Beach, CA (US)

Correspondence Address: Madison Valencia PLLC, 13800 Coppermine Road, Herndon, VA, 20171, US

(21) Appl. No.: 12/559,460

(22) Filed: Sep. 14, 2009

Related U.S. Application Data
(60) Provisional application No. 61/136,543, filed on Sep. 12, 2008.

(51) Int. Cl. G06Q 30/00; G06F 15/16

(52) U.S. Cl. 705/14.64; 709/206

(57) ABSTRACT

A system and method that analyze content of an electronic message to determine advertisements that may be relevant to the content. Relevant advertisements may be presented to the user. The user may select one or more advertisements to be transmitted with the message to a message recipient or may be automatically appended to the message. The advertisements are presented to the message recipient with the message. The user may be compensated based on activity associated with the message.

### RELATED APPLICATIONS

This application claims priority to U.S. Provisional Patent Application Ser. No. 61/136,543, titled “System and Method of Providing Peer-to-Peer Message-Based Advertising” and filed on Sep. 12, 2008, the entirety of which is herein incorporated by reference.

### SUMMARY OF THE INVENTION

According to one embodiment, the invention includes a system and method of providing peer-to-peer message-based advertising. The invention enables users of electronic messaging such as, for example, electronic mail, instant messaging (IM), social networking messaging, and short message service (SMS) to insert advertisements into a message to be transmitted. According to one embodiment, the invention analyzes content of an electronic message, answers provided by a user, demographic attributes of a recipient or other information to determine advertisements that may be relevant to the content. Relevant advertisements may be presented to the user. The user may select one or more advertisements to be transmitted with the message to a message recipient or may be automatically appended to the message. The advertisements are presented to the message recipient with the message.

According to one embodiment of the invention, the user may be compensated directly or indirectly based on advertisements selected by the message recipient. For example, the user may be compensated directly by receiving a reward such as, for example, cash, frequent flier miles, gift certificate or points to be used for receiving such rewards. Compensation may be provided, for example, each time a message recipient selects or views an advertisement transmitted with a message and if the message recipient purchases a product or service referred to in the advertisement or purchased as a result of viewing the advertisement.

Alternatively, the user may be indirectly compensated by, for example, having a donation made to a charity of the user's choice each time a message recipient views, selects, and/or purchases a product or service associated with the advertisement. Charitable donations may also vary depending on an extent to which the message recipient uses the advertisement.

Further applications and advantages of various embodiments of the invention are discussed below with reference to the drawing figures.

### BRIEF DESCRIPTION OF THE DRAWINGS

FIGS. 1A-1B are flow charts of a method of providing peer-to-peer message-based advertising according to one embodiment of the invention.

FIG. 2 is an illustration of a peer-to-peer message-based advertising system according to one embodiment of the invention.

FIG. 3 is an illustration of a peer-to-peer message-based advertising system according to one embodiment of the invention.

FIG. 4 is a flow chart of a method of compensating a user of a peer-to-peer message-based advertising system according to one embodiment of the invention.

FIG. 5 is an illustration of a system of compensating users of a peer-to-peer message-based advertising system according to one embodiment of the invention.

FIG. 6 is a flow chart of a method of providing peer-to-peer advertising system according to one embodiment of the invention.

FIG. 7 is an illustration of a peer-to-peer advertising system according to one embodiment of the invention.

### DETAILED DESCRIPTION OF THE INVENTION

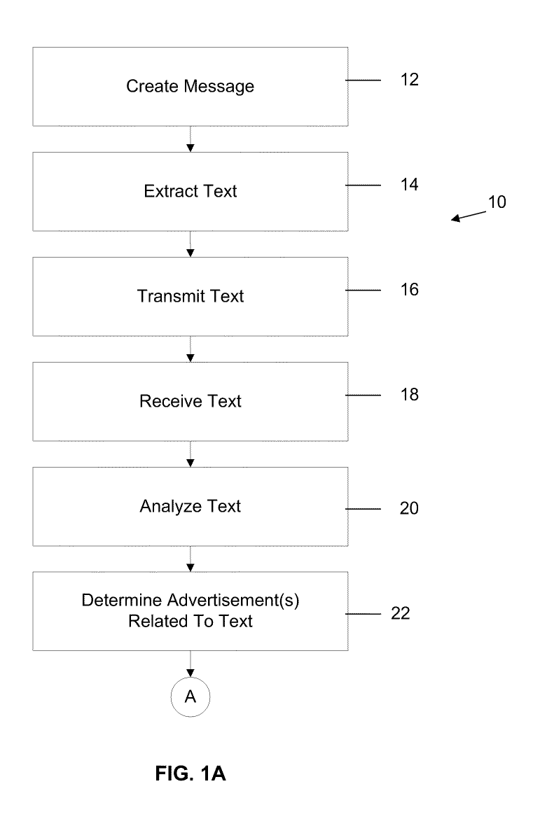

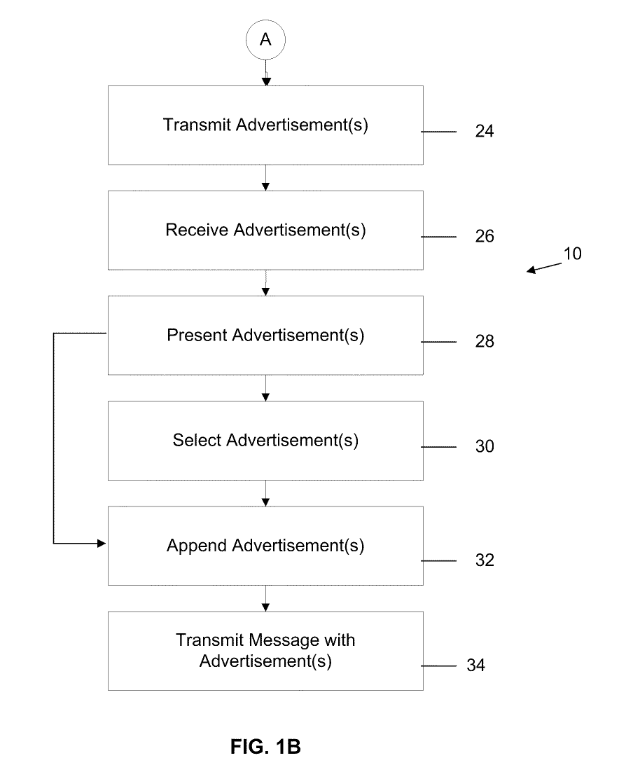

FIGS. 1A-1B illustrate a method 10 of providing peer-to-peer message based advertising according to one embodiment of the invention. The method 10 includes enabling a user to create an electronic message, step 12, using any known electronic message system such as, for example, electronic mail, instant messaging (IM), social networking messaging, short message service (SMS). Creating an electronic message may include, for example, creating a new message, replying to a received message, forwarding a received message to one or more users or other method. The user may create the message using a client device such as, for example, a desktop computer, laptop computer, notebook computer, tablet computer, personal digital assistant (PDA), mobile phone or other device or terminal. The user creates a message that includes text. After creating the message, the text is extracted from the message in step 14 and transmitted in step 16 to, for example, a server that receives the text, step 18. The text is analyzed using any suitable analyzing mechanism to determine whether one or more advertisements are related to the text, step 20. It is to be understood that the text that is analyzed may include text input by the user and/or any text included in a message thread if the message is in response to a received message such as a reply to or forwarding of the received message.

According to one embodiment, the server may determine advertisements that are related using one or more various technologies such as, for example, keyword mapping, natural language processing, machine learning or other technology. Using one or more such technologies, the server interprets the text to ascertain a meaning of the text. Based on a context of the message, the server may determine whether one or more advertisements are related to the text, step 22. According to one embodiment, the advertisements may be stored locally on the server, at a remote server or other location.

The advertisements determined to be related to the text are transmitted to, step 24, and received by, step 26, the client device. The advertisements are presented to the user on a display of the client device, step 28. The user may select one or more of the advertisements to append to the message created by the user, step 30. The advertisements may be selected using any input device such as, for example, a keyboard, computer mouse, keypad, trackball, stylus, light pen or any other input device. Alternatively, the method 10 may automatically append one or more advertisements to the message. The method 10 may use, for example, a priority or ranking system to select one or more advertisements that may be determined to be related, suitable or other criteria to append to the message. Other criteria for selecting the advertisements that are appended to the message may also be used. The advertisements selected are appended to the message, step 32, and the message is transmitted with the advertisements appended in response to a transmit command input by the user, step 34.

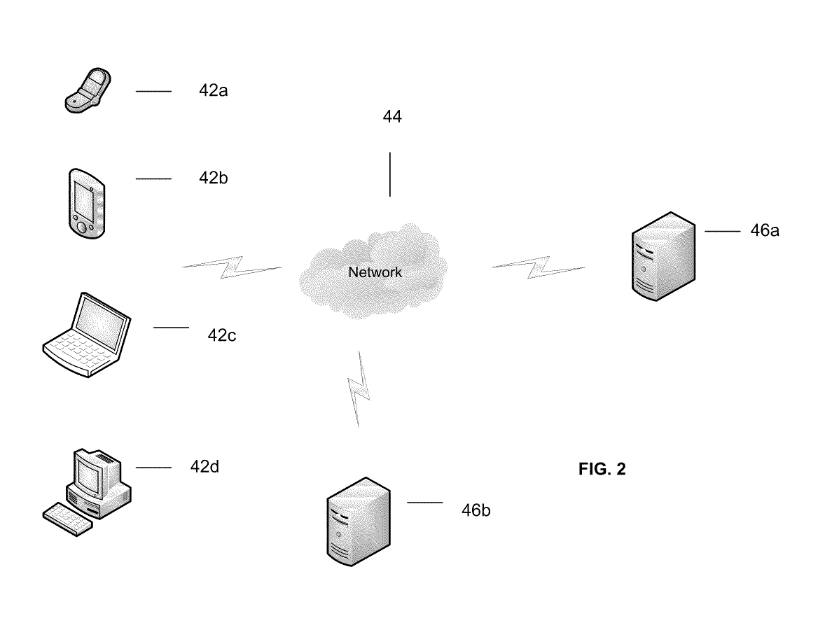

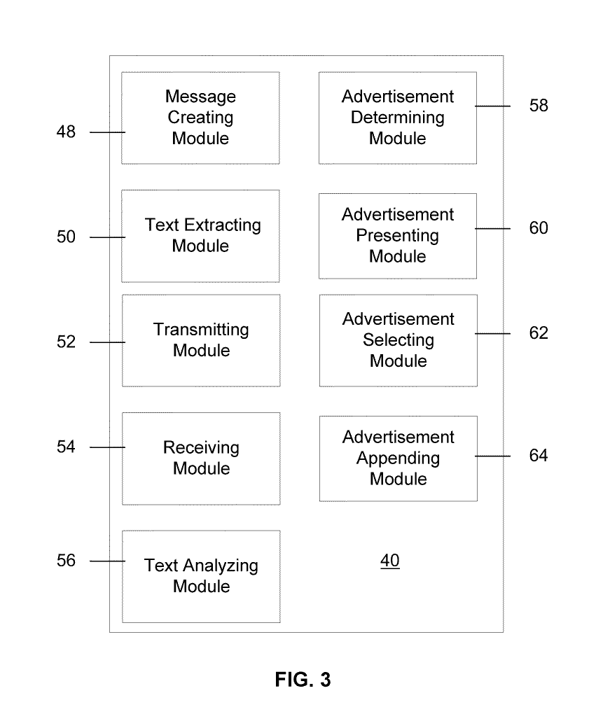

FIGS. 2-3 illustrate a system 40 of providing peer-to-peer message-based advertising according to one embodiment of the invention. The system 40 illustrated is in a client/server architecture form, although other forms may also be used. The system includes client devices such as, for example, a mobile phone 42a, smartphone 42b, laptop computer 42c, desktop computer 42d or other device such as a personal digital assistant (PDA) that communicates over a network 44 with one or more servers 46a, 46b. Users of the client devices 42a-42d create electronic messages to transmit over the network 44. System 40 enables users to append or system 40 to automatically append advertisements to the messages such that the user receives compensation for activity that occurs relating to the advertisements.

According to one embodiment of the invention, users create an electronic message, using a message creating module 48, that includes text using any electronic messaging system such as, for example, electronic mail, instant messaging (IM), social networking messaging, short message service (SMS) or other system. The message may be created by, for example, creating a new message, replying to a received message, forwarding a received message or other method. A text extracting module 50 may enable the text to be extracted from the message. A transmitting module 52 transmits the text that is received by a receiving module 54 and analyzed by a text analyzing module 56. As stated above, any text extracted may be text input by the user and/or included in a message thread if the message created is in response to a received message such as by replying to or forwarding the received message. The text analyzing module 56 analyzes the text of the message to determine a context of the message. An advertisement determining module 58 determines whether any advertisements, either stored locally or remotely from the server, are related, suitable or otherwise desired to be appended to the text of the message. If a determination is made that one or more advertisements are related to the text, the advertisements may be transmitted, received, and presented, using an advertisement presenting module 60, on a display of the client device of the user of the client device that created the message.

The system enables the user to select one or more of the advertisements to be appended to the message, using an advertisement selecting module 62, using an input device such as, for example, a keyboard, computer mouse, keypad, trackball, stylus, light pen or any other input device. The advertisements selected by the user may be appended to the message using an advertisement appending module 64 and the message may be transmitted to a message recipient using the transmitting module. Alternatively, the system 40 may automatically append one or more advertisements to the message. The system 40 may use, for example, a priority or ranking system to select one or more advertisements that may be determined to be related, suitable or other criteria to append to the message. Other criteria for selecting the advertisements that are appended to the message may also be used. According to one embodiment, each module resides on the client device. Alternatively, all or a portion of the modules may reside on a server. For example, the text analyzing and advertisement determining modules 56, 58 may reside on a server and the remaining modules may reside on the client device. Other arrangements may also be used.

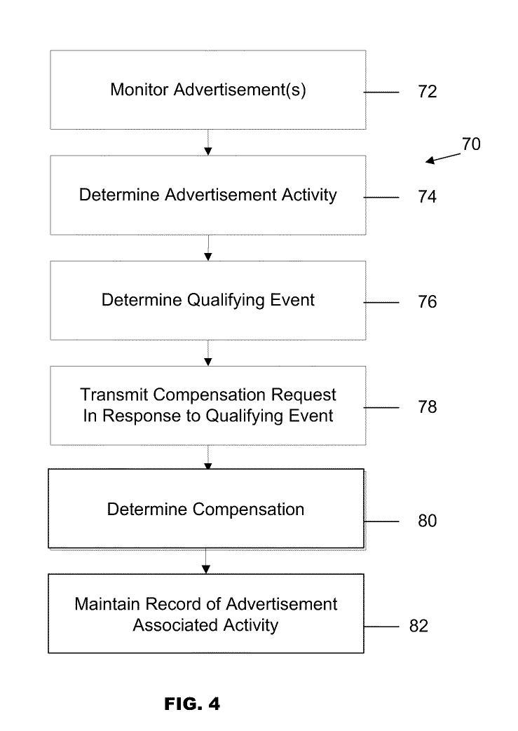

FIG. 4 illustrates a method 70 of compensating a user based on advertisement activity, according to one embodiment of the invention. The method 70 includes monitoring advertisements that have been transmitted with messages created by one or more users, step 72. The method 70 determines whether there has been any activity relating to one or more advertisements transmitted with an electronic message, step 74. The activity may include, for example, whether the advertisement has been viewed, selected by a message recipient or transmitted to another message recipient. The activity may also include whether a message recipient has purchased a product or service that is a subject of the advertisement or purchased another product or service that is offered by a provider of the product or service described in the advertisement.

The method 70 determines whether any of the activities constitute a qualifying event, step 76. A qualifying event may be, for example, activity for which a user, who caused the advertisement associated with the activity to be transmitted, may be compensated. Compensation may be direct or indirect. Direct compensation may be, for example, providing a cash reward, frequent flier miles, points that may be used for purchasing goods or services, gift certificate or other benefit. Indirect compensation may be, for example, a donation made to a charity of the user's choice.

If a determination is made that a qualifying event has occurred, the method 70 may transmit a compensation request to a server or other device that fulfills the request, step 78. Fulfilling the request may include, for example, determining compensation associated with the advertisement activity, step 80. Compensation may be in a form of, for example, a check mailed to the user or a charity of the user's choice, money deposited into an account of the user using an electronic funds transfer, crediting a frequent flier program of the user with a predetermined number of miles or a points program with a predetermined number of points or other benefit.

According to one embodiment, the method 70 may use a cost per mille (CPM) advertising mechanic to determine compensation for a user. Using a CPM advertising mechanic, a user may be compensated each time an advertisement that has been transmitted with a message created by the user is viewed. Alternatively, the method may use a cost per action (CPA) advertising mechanic. Using a CPA advertising mechanic, a user may be compensated each time an advertisement that has been transmitted with a message created by the user is selected by a message recipient. Other methods of determining compensation may also be used.

Compensation may vary depending on the activity determined. For example, a user may be compensated in an amount of one cent (1¢) for each time an advertisement transmitted with a message created by that user is viewed, two cents (2¢) for each time the advertisement is selected by a message recipient, one dollar ($1.00) for each product described in the advertisement or other product or service offered by a provider of the product or service is purchased by the message recipient. Other methods and combinations thereof may also be used. Additionally, compensation amounts for each activity may vary depending on the user, provider, product/service, message recipient or other factor.

According to one embodiment of the invention, the method 70 may also maintain a record of advertisement activity, step 82. The record may include, for example, which advertisements are selected for which message recipients, which advertisements are viewed and/or selected by message recipients, a number of times that an advertisement is viewed and/or selected, whether any purchases were made in response to the advertisement or other criteria.

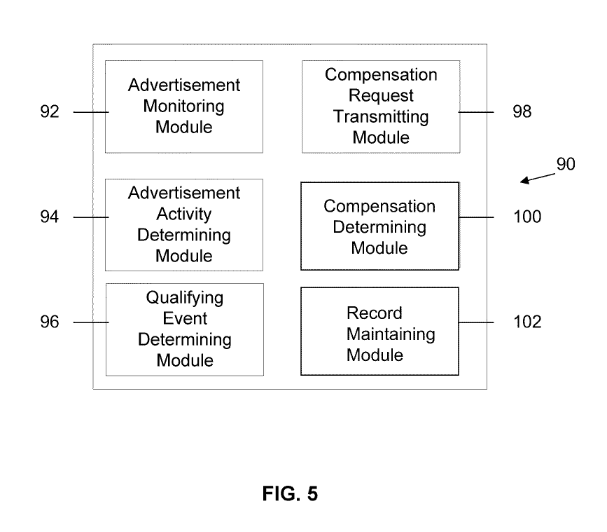

FIG. 5 illustrates a system 90 of compensating a user of a transmitted advertisement, according to one embodiment of the invention. The system 90 includes an advertisement monitoring module 92 that monitors whether activity associated with an advertisement has occurred. If there has been advertisement activity, an advertisement activity determining module 94 may determine a type of activity that has occurred. The activity may include, for example, whether the advertisement has been viewed, selected by a message recipient, transmitted to another message recipient, whether a message recipient has purchased a product or service that is a subject of the advertisement or offered by a provider of the product or service described in the advertisement or other activity.

Monitoring may be done actively or passively. For example, upon occurrence of predetermined activity, a message may be transmitted to, for example, a server that maintains a record of advertisement activity. Alternatively, a request for advertisement activity may be transmitted to, for example, a server that transmits activity identifying information to a requesting device. The request may include a request for activity associated with, for example, a particular advertisement, a particular provider of products or services, a particular user or other criteria.

The system 90 also includes a qualifying event determining module 96 that determines whether an activity determined to have occurred is a qualifying event. A qualifying event may be, for example, an activity for which a user who transmitted the advertisement associated with the activity may be compensated. Compensation may be direct or indirect as described above. A compensation request transmitting module 98 may be used to transmit a request to, for example, a server that processes such requests, for processing of the compensation that the user is to receive. A compensation module 100 may be used to determine compensation that a user is to receive based on advertisement activity. Compensation may be, for example, cash, frequent flier miles, a charitable donation, points or other benefit. A record maintaining module 102 may be used to maintain a record of activity associated with an advertisement. For example, the record may include each occurrence of activity as described above. Also, the record may include compensation associated with the advertisement that has been provided, users that have received the compensation, providers of the product or service described in the advertisement or other information.

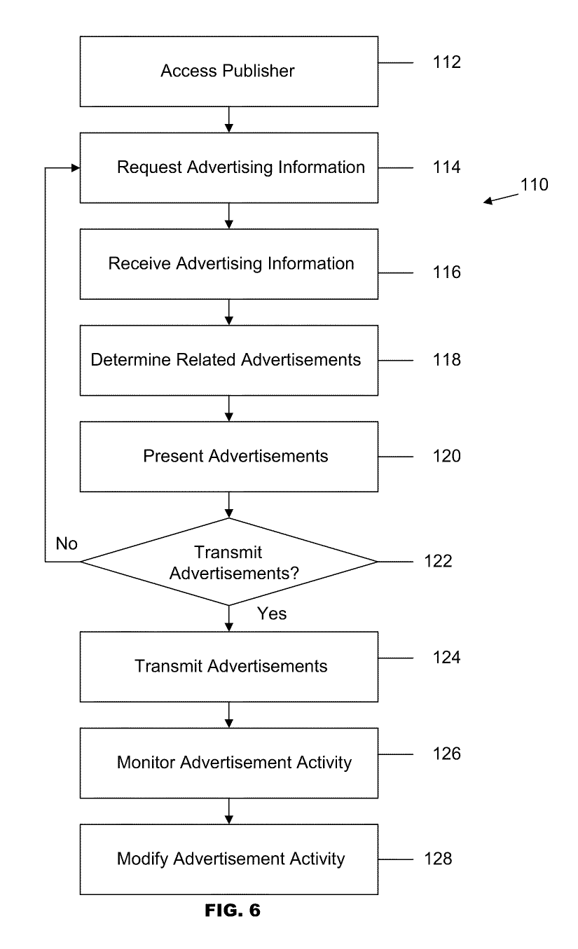

FIG. 6 is an illustration of a method 110 of providing peer-to-peer advertising according to one embodiment of the invention. The method 110 includes an access publisher step 112 in which a user may access a publisher of advertisements. The publisher may be a web site such as, for example, a search engine or social networking site or an application provided on, for example, a web site or mobile device. The publisher may request advertising information from the user, step 114, to determine potential advertisements that the user may transmit to another user. The advertising information may be in a form of, for example, a survey or other list of questions that elicits information that may be used to determine the potential advertisements, demographic information of a potential recipient determined by, for example, the publisher or other information. According to one embodiment, the potential advertisements are user-specific and related to a potential need of the user. For example, the user may be asked whether any known users are single, unemployed, pregnant, attempting to quit smoking or other attribute. Advertisers associated with such attributes may be used to provide the users with potentially desirable advertisements.

The advertising information may be received by, for example, a server that processes the information, step 116. The server may determine potential advertisements based on the information received, step 118. The server may then present the advertisements to the user, step 120. A determination is made regarding whether to transmit one or more of the advertisements to another user, step 122. This may be based on, for example, input received from the user after receiving a query from the method 110 regarding whether to transmit one or more of the advertisements. If a determination is made not to transmit any of the advertisements, the method 110 may return to step 114.

If a determination is made to transmit one or more of the advertisements, the method 110 may transmit the advertisements, step 124. The method 110 may monitor activity associated with the advertisements, step 126. For example, the method 110 may monitor which users answer questions providing advertising information and transmit advertisements as well as whether recipients of advertisements have viewed, selected, purchased or otherwise acted upon the advertisements. The advertisement activity may be used to modify questions presented to users, alter advertisements presented to users based on answers to the questions or other basis, step 128. According to one embodiment of the invention, the user sending the advertisement may be compensated for activity associated with the advertisement as described above.

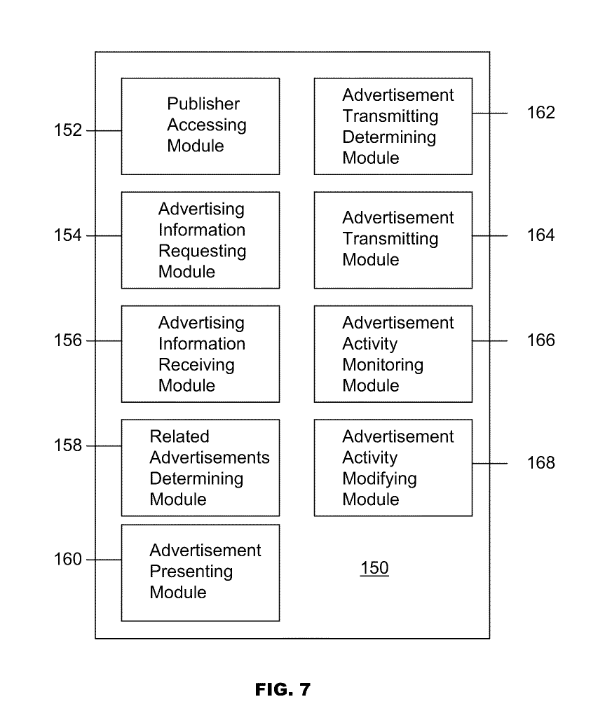

FIG. 7 illustrates a system 150 of providing peer-to-peer advertising according to one embodiment of the invention. The system 150 may include a publisher accessing module 152 that enables a user to access a publisher, such as, for example, a web site or application. An advertising information requesting module 154 may be used to request information from the user that may be used to select one or more potential advertisements that the user may desire to transmit to another user. The advertising information requesting module 154 may present the user with a survey or series of questions that enable the system 150 to determine which advertisements a potential recipient may desire.

Alternatively, the advertising information may be demographic attributes of a potential recipient determined by, for example, a publisher. Other types of information may also be used. According to one embodiment, the potential advertisements are user-specific and related to a potential need of the user. For example, the user may be asked whether any known users are single, unemployed, pregnant, attempting to quit smoking or other attribute. Advertisers associated with such attributes may be used to provide the users with potentially desirable advertisements. Information input by the user may be received by advertisement information receiving module 156. A related advertisements determining module 158 may be used to determine one or more advertisements that may be potentially related to the advertisement information received from the user.

If one or more advertisements are determined to be potentially related to the advertisement information, an advertisement presenting module 160 may be used to present the advertisements to the user. An advertisement transmitting determining module 162 may be used to determine whether the user desires to transmit one or more of the advertisements to another user. This may be based on input received from the user based on a query from the system 150. If a determination is made that the user desires to transmit one or more of the advertisements to another user, the advertisements may be transmitted using advertisement activity transmitting module 164.

An advertisement activity monitoring module 166 may be used to monitor activity associated with the advertisement. For example, advertisement activity monitoring module 166 may monitor which users answer questions providing advertising information, transmit advertisements as well as whether recipients of advertisements have viewed, selected, purchased or otherwise acted upon the advertisements. The advertisement activity may be used to modify questions presented to users, alter advertisements presented to users based on answers to the questions or other basis using advertisement activity modifying module 168. According to one embodiment of the invention, the user sending the advertisement may be compensated for activity associated with the advertisement as described above.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein. For example, although the invention is described in terms of a client/server architecture, other forms may also be used. Also, although the invention is described in terms of a server analyzing the text of a message, storing advertisements, and determining advertisements related to the text of the message, these and the other steps described above may be performed locally by a client without use of a server.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

What is claimed is:

1. A method of providing peer-to-peer message-based advertising comprising:
receiving at least a portion of text of an electronic message;
analyzing the text;
determining whether an advertisement is related to the text;
selecting an advertisement; and
transmitting the advertisement.

2. The method of claim 1, further comprising automatically appending the advertisement to the message.

3. The method of claim 1, further comprising enabling the user to select the advertisement to append to the message.

4. The method of claim 1, further comprising monitoring the advertisement.

5. The method of claim 1, further comprising determining whether any advertisement activity has occurred.

6. The method of claim 3, further comprising determining whether the activity qualifies as a qualifying event.

7. The method of claim 3, further comprising maintaining a record of the advertisement activity.

8. The method of claim 1, further comprising transmitting a compensation request.

9. A system of providing peer-to-peer message based advertising comprising:
a receiving module configured to receive at least a portion of text of an electronic message;
an analyzing module configured to analyze the text;
a determining module configured to determine whether an advertisement is related to the text;
a selecting module configured to select an advertisement; and
a transmitting module configured to transmit the advertisement.

10. The system of claim 9, further comprising an advertisement appending module configured to append the advertisement to the message.

11. The system of claim 9, further comprising an enabling module configured to enable a user to select the advertisement to append to the message.

12. The system of claim 9, further comprising a monitoring module configured to monitor the advertisement.

13. The system of claim 9, further comprising an activity determining module configured to determine whether any advertisement activity has occurred.

14. The system of claim 13, further comprising an event determining module configured to determine whether the activity qualifies as a qualifying event.

15. The system of claim 13, further comprising a record maintaining module configured to maintain a record of the advertisement activity.

16. The system of claim 9, further comprising a compensation determining module configured to determine compensation associated with the advertisement activity.

17. The system of claim 16, wherein the compensation determining module uses any one of a cost-per-mille and a cost-per-action advertising mechanic.

18. The system of claim 9, wherein the message is any one of an electronic mail message, text message, short message service (SMS) message, instant message, and a social networking message.

19. The system of claim 9, wherein the determining module determines a related advertisement using any one of keyword mapping, natural language processing, and machine learning.

20. A method of providing peer-to-peer message based advertising comprising:
extracting at least a portion of text from an electronic message;
transmitting the text;
receiving at least one advertisement;
selecting the advertisement;
appending the advertisement to the message; and
transmitting the message with the advertisement.
